(19) United States
(12) Patent Application Publication
(10) Pub. No.: US 2007/0091053 A1
(43) Pub. Date: Apr. 26, 2007

(54) Display device

(76) Inventors: Hisayoshi Kajiwara, Yokohama (JP); Tsutomu Furuhashi, Yokohama (JP); Hiroyuki Nitta, Fujisawa (JP); Naoki Takada, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/545,686

(22) Filed: Oct. 11, 2006

(30) Foreign Application Priority Data
Oct. 20, 2005 (JP) 2005-306156

(51) Int. Cl. G09G 3/36

(52) U.S. Cl. 345/100

(57) ABSTRACT

Output voltages of R-2R ladder resistor type digital-to-analog conversion circuits are once stored in sample and hold capacitors through sample and hold charging amplifiers and the voltages stored in the capacitors are then supplied to a liquid crystal panel through panel drive amplifiers and multiplexers simultaneously. Power supplies to the digital-to-analog conversion circuits and the charging amplifiers are turned on by means of switches only during the period that the voltages are written in the capacitors and turned off during other periods. Two systems of the capacitors and the panel drive amplifiers are provided in order to make the operation of charging the analog voltages to the capacitors and the operation of taking out the analog voltages stored in the capacitors to supply the voltages to the liquid crystal panel in parallel.

### CLAIM OF PRIORITY

The present application claims priority from Japanese application serial No. 2005-306156 filed on Oct. 20, 2005, the content of which is hereby incorporated by reference into this application.

### BACKGROUND OF THE INVENTION

The present invention relates to a display device which converts digital display data into analog voltages to drive a display panel and more particularly to a display device such as a liquid crystal display device and an organic EL (Electro-Luminescence) display device.

A prior-art liquid crystal drive circuit for driving a liquid crystal panel is described in U.S. Pat. No. 6,677,923 (JP-A-2002-175060), for example. This prior-art liquid crystal drive circuit is now described with reference to FIGS. 19-21.

FIG. 19 is a schematic diagram illustrating an example of the prior-art liquid crystal drive circuit. This liquid crystal drive circuit includes a shift register 101, first latch circuits 102, second latch circuits 103, selector circuits 201, panel drive amplifiers 105, multiplexers 106, a high-potential side gradation voltage generation circuit 202 and a low-potential side gradation voltage generation circuit 203. Numeral 107 denotes output terminals connected to a liquid crystal panel, 108 a bus for transmitting a line period clock (CL1), 109 a bus for transmitting a pixel clock (CL2), 110 a bus for transmitting digital display data, 204 a bus for transmitting 256 gradation voltages on the high potential side, 205 a bus for transmitting 256 gradation voltages on the low potential side, 206 a bus for transmitting reference voltages on the high potential side, and 207 a bus for transmitting reference voltages on the low potential side.

The gradation voltage generation circuits 202 and 203, the selector circuits 201 and the panel drive amplifiers 105 each include high-potential side circuits operated at a potential higher than a common potential VCOM of liquid crystal and low-potential side circuits operated at a potential lower than the common potential VCOM, and the high- and low-potential side circuits are disposed or connected alternately. The liquid crystal drive circuit of FIG. 19 shows a case of 256 gradations having 8 bits for each RGB data of the digital display data, as a definite example.

In FIG. 19, the digital display data supplied from an external timing controller (control means) is sequentially taken in the first latch circuits 102 in data for one pixel constituted by 3 data of RGB by action of the shift register 101 operated in synchronism with the pixel clock CL2. The digital display data outputted by the first latch circuits 102 are simultaneously supplied to the selector circuits 201 through the second latch circuits 103 at each horizontal scanning timing by action of the second latch circuit 103 operated in synchronism with the line period clock CL1. The selector circuits 201 select the gradation voltages corresponding to the digital display data outputted by the second latch circuits 103 from among the gradation voltages outputted by the gradation voltage generation circuits 202 and 203 and output the selected gradation analog voltages. The analog voltages outputted by the selector circuits 201 are supplied through the panel drive amplifiers 105 and the multiplexters 106 to the liquid crystal panel.

The gradation voltage generation circuits 202 and 203 divide a plurality of externally supplied reference voltages V1 to V17 by voltage dividers composed of a plurality of resistor elements to produce 256 gradation voltages corresponding to 8 bits.

FIG. 20 is a schematic diagram illustrating the high-potential side gradation voltage generation circuit 202 shown in FIG. 19. The gradation voltage generation circuit 202 divides the plurality of externally supplied reference voltages V0 to V8 by the voltage divider composed of 256 resistor elements 301 to generate 256 gradation voltages. The same is also applied to the low-potential side gradation voltage generation circuit 203. In FIG. 20, numeral 302 denotes a bus for transmitting the reference voltages and 303 a bus for transmitting the gradation voltages.

FIG. 21 is a schematic diagram illustrating the selector circuit 201 shown in FIG. 19. The selector circuit 201 includes switching elements 401 formed of MOS transistors arranged in the form of tournament. The MOS switching elements 401 are turned on and off by 8-bit RGB digital display data to selectively output the gradation voltage corresponding to the 8-bit digital display data from among all the gradation voltages generated by the gradation voltage generation circuit. In FIG. 21, numeral 402 denotes a bus for transmitting the 8-bit digital display data, 403 a bus for transmitting the gradation voltages, and 404 an output terminal.

### SUMMARY OF THE INVENTION

As one of elements for deciding the picture quality of the liquid crystal display device, there is the number of colors which the liquid crystal display device can express or produce. For example, when the digital display data is 8 bits, the number of gradations of RGB is 2⁸=256 and the number of expressible colors is 256×256×256=16,780,000. On the other hand, when the digital display data is 10 bits, the number of gradations of RGB is 2¹⁰=1024 and the number of expressible colors is 1024×1024×1024=1,073,740,000. In this manner, the number of bits of the digital display data can be increased to increase the number of gradations, so that the number of expressible colors can be increased greatly to attain the high picture quality.

The problems caused when the number of bits is increased in the above-mentioned prior-art liquid crystal device are now described. The liquid crystal drive circuit in the prior-art liquid crystal display device makes digital-to-analog conversion (D/A conversion) by means of the selector circuits 201 shown in FIG. 21. The relation of the number of bits of the digital display data and the circuit scale of the selector circuits is now considered.

As shown in FIG. 21, when the digital display data is 8 bits, the number of MOS switches contained in the 8-bit selector circuit is 2¹+2²+2³+2⁴+2⁵+2⁶+2⁷+2⁸=510 since each of the switching elements 401 are composed of 2 MOS switches.

On the other hand, as shown in FIG. 22, when the digital display data is 10 bits, the number of MOS switches-contained in the 10-bit selector circuit is 2¹+2²+2³+2⁴+2⁵+2⁶+2⁷+2⁸+2⁹+2¹⁰=2046.

As described above, in the D/A conversion system using the prior-art selector circuit, when the number of bits of the digital display data is increased, the number of MOS switches contained in the selector circuit is remarkably increased and accordingly there is a problem that an area for the layout of the D/A conversion circuits is remarkably increased with the increase of the number of bits.

Further, since the number of gradations is remarkably increased with the increase of the number of bits, the number of buses for transmitting the gradation voltages generated by the gradation voltage generation circuit is also remarkably increased, so that an area occupied by the buses themselves also comes into question.

As described above, in the prior art, since the circuit scale of the liquid crystal drive circuit is remarkably increased with the increase of the number of bits, there is a problem that the liquid crystal display device having multiple gradations and high picture quality cannot be realized at a low cost.

It is an object of the present invention to solve the above problems in the prior art by realizing a display device having multiple gradations and high picture quality at a low cost and in low power consumption.

According to the present invention, a digital-to-analog (hereinafter abbreviated to D/A) conversion circuits of the display device use R-2R ladder resistor type D/A conversion circuits well-known as linear D/A conversion circuits instead of the selector circuits used in the prior art. The R-2R ladder resistor type D/A conversion circuits can be constituted by elements equal in number to about several times as many as the number of bits of the digital display data and accordingly the layout area of the D/A conversion circuits can be reduced. Further, since the R-2R ladder resistor type D/A conversion circuits are operated with only digital input and reference voltage, the gradation voltage generation circuit and the bus for transmitting the gradation voltages, both of which are required in the conventional selector circuit system, are not necessary. Therefore, the chip size of the drive circuit can be reduced as compared with the system using the conventional selector circuits.

Further, according to the present invention, sample and hold (hereinafter abbreviated to S/H) circuits are disposed on the output side of the R-2R ladder resistor type D/A conversion circuits, so that analog voltages are once stored in the S/H circuits and then supplied to the liquid crystal panel simultaneously. The S/H circuits can store the analog voltages in a capacitance elements and since the capacitance elements have as small capacitance as several picofarads (pF), the analog voltages can be written into the capacitance elements in a very small time as compared with a horizontal scanning time 1 H. Accordingly, the R-2R ladder resistor type D/A conversion circuits are supplied with electric power only during the period that the analog voltages are being written in the S/H circuits and not supplied with electric power during other periods except the above-mentioned period, so that the power consumption of the R-2R ladder resistor type D/A conversion circuits can be reduced greatly.

Moreover, according to the present invention, since the R-2R ladder resistor type D/A conversion circuits are of the linear type, data conversion means is required separately in order to make gamma correction. Accordingly, conversion tables (hereinafter referred to-as “look-up tables”) for converting the digital display data are provided on the side of control means (hereinafter referred to as “timing controller”) for each of RGB, so that setting of gamma is made in each of RGB on the side of the timing controller.

According to the present invention, since the R-2R ladder resistor type D/A conversion circuits are applied to the D/A conversion circuits of the display device, the layout area of the D/A conversion circuits can be reduced greatly as compared with the conventional selector circuits. Further, the gradation voltage generation circuit required in the conventional display device and the bus for transmitting the gradation voltages are not necessary. Accordingly, the display device having multiple gradations and high picture quality can be realized with a small chip.

Furthermore, according to the present invention, since the power consumption of the R-2R ladder resistor type D/A conversion circuits can be reduced by means of the method using the S/H circuits, the liquid crystal drive circuit having lower power consumption can be provided.

Moreover, the gamma setting can be made for each of RGB by making conversion of the digital display data by means of the look-up tables disposed in the timing controller for each of RGB to thereby attain color reproduction with high quality.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic diagram illustrating a liquid crystal display device according to the present invention;

FIG. 2 is a schematic diagram illustrating a liquid crystal drive circuit (drain driver) shown in FIG. 1;

FIG. 3 is a schematic diagram illustrating an analog circuit part shown in FIG. 2;

FIG. 4 is a schematic diagram illustrating a high potential side of R-2R ladder resistor type D/A conversion circuit shown in FIG. 3;

FIG. 5 is a schematic diagram illustrating a low potential side of R-2R ladder resistor type D/A conversion circuit shown in FIG. 3;

FIG. 6 is a diagram showing setting of voltages and an operation range of output voltage of the high-potential side R-2R ladder resistor type D/A conversion circuit shown in FIG. 4;

FIG. 7 is a diagram showing setting of voltages and an operation range of output voltage of the low-potential side R-2R ladder resistor type D/A conversion circuit shown in FIG. 5;

FIG. 8 is a timing chart showing operation of the liquid crystal drive circuit shown in FIG. 1;

FIG. 9 is anther timing chart showing operation of the liquid crystal drive circuit shown in FIG. 1;

FIG. 10 is a schematic diagram illustrating a timing controller shown in FIG. 1;

FIG. 11 is a graph explaining conversion of digital display data by means of look-up tables shown in FIG. 10;

FIG. 12 is a graph showing the gamma curve set in γ=2.2;

FIG. 13 is a graph explaining color shift caused when the gamma setting is common to RGB;

FIG. 14 is a graph showing the gamma curve in which the color shift shown in FIG. 13 is corrected;

FIG. 15 is another schematic diagram illustrating the timing controller shown in FIG. 1;

FIG. 16 is another schematic diagram illustrating the liquid crystal drive circuit (drain driver) shown in FIG. 1;

FIG. 17 is a schematic diagram illustrating an analog circuit part shown in FIG. 16:

FIG. 18 is a timing chart showing operation of the liquid crystal drive circuit shown in FIG. 16;

FIG. 19 is a schematic diagram illustrating a prior-art liquid crystal drive circuit;

FIG. 20 is a schematic diagram illustrating a gradation voltage generation circuit shown in FIG. 19;

FIG. 21 is a schematic diagram illustrating a selector circuit shown in FIG. 19; and

FIG. 22 is another schematic diagram illustrating the selector circuit shown in FIG. 19;

### DESCRIPTION OF THE EMBODIMENTS

### Embodiment 1

An embodiment 1 of a liquid crystal display device using a liquid crystal drive circuit according to the present invention is now described with reference to FIGS. 1 to 15.

FIG. 1 schematically illustrates a liquid crystal display device of the embodiment. The liquid crystal display device includes a liquid crystal panel 601, drain drivers 607, gate drivers 608 and control means (hereinafter referred to as “timing controller”) 609. The liquid crystal panel 601 includes a large number of drain lines 603 and gate lines 602 arranged reticulately in the longitudinal direction and in the lateral direction, respectively, and display parts disposed at intersection points of the drain lines 603 and the gate lines 602 and each including a switching transistor 604 and a liquid crystal display element 605. Numeral 606 denotes a common electrode of the liquid crystal. The drain lines 603 and the gate lines 602 are driven by a plurality of drain drivers 607 and gate drivers 608, respectively, and are controlled by the timing controller 609. Numeral 610 denotes a bus for transmitting control signal and digital display data, 611 a bus for transmitting control signal, and 612 a bus for transmitting input picture data.

In FIG. 1, a picture is displayed in the liquid crystal panel 601 as follows. The plurality of gate drivers 608 successively produce signals for turning on the transistors 604 on the gate lines 602 line by line from the gate line positioned uppermost of the liquid crystal panel 601 toward the gate line positioned lowermost thereof. In each gate line 602, the plurality of drain drivers 607 simultaneously produce analog voltages corresponding to the digital display data for the gate line 602 at the timing that the transistors 604 on the gate line 602 are turned on to write the analog voltages to the liquid crystal display elements 605. In this manner, the analog voltages corresponding to the digital display data are successively written in the liquid crystal display elements 605 from the topmost gate line to the lowest gate line to thereby complete display of the picture for one frame. Further, this series of operations is repeated to display the dynamic picture composed of numerous frames.

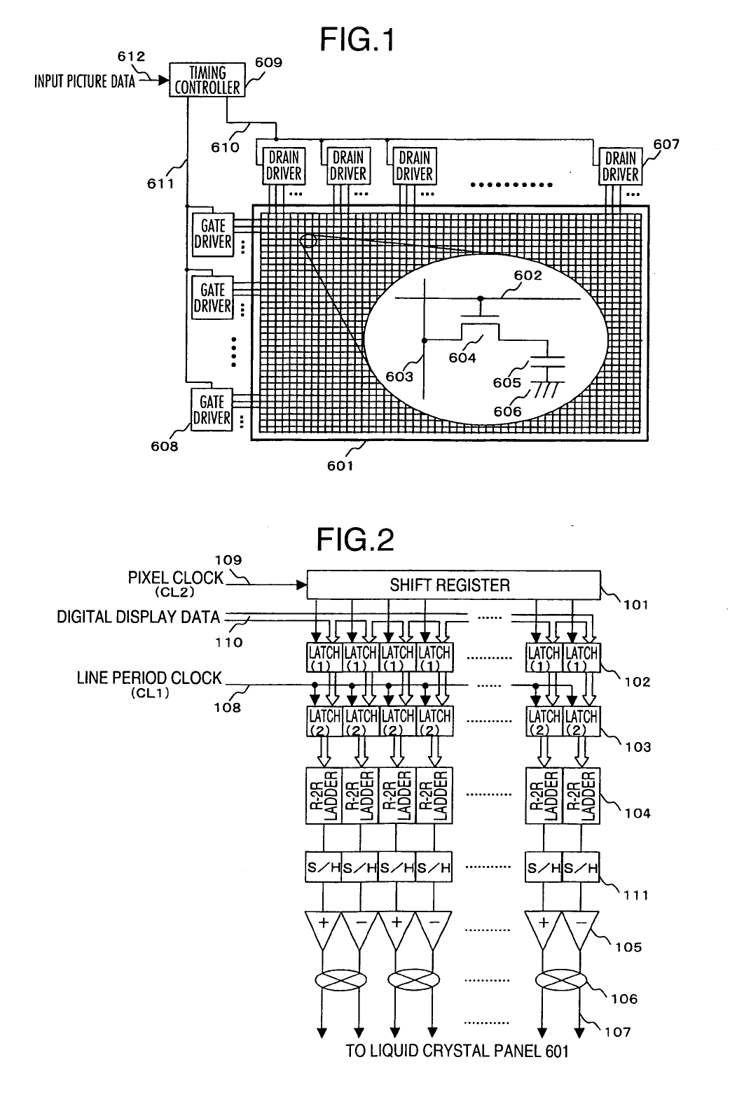

FIG. 2 schematically illustrates the liquid crystal drive circuit (drain driver) shown in FIG. 1. The liquid crystal drive circuit includes a shift register 101, first latch circuits 102, second latch circuits 103, R-2R ladder resistor type digital-to-analog (hereinafter abbreviated to “D/A”) conversion circuits 104, sample and hold (hereinafter abbreviated to “S/H”) circuits 111, panel drive amplifiers 105 and multiplexers 106. Numeral 107 denotes output terminals connected to the liquid crystal panel 601, 108 a bus for transmitting a line period clock (CL1), 109 a bus for transmitting a pixel clock (CL2), and 110 a bus for transmitting the digital display data.

The R-2R ladder resistor type D/A conversion circuits 104, the S/H circuits 111 and the panel drive amplifiers 105 each include high-potential side circuits operated at a potential higher than the common potential VCOM of the liquid crystal and low-potential side circuits operated at a potential lower than the common potential VCOM, and the high- and low-potential side circuits are disposed or connected alternately.

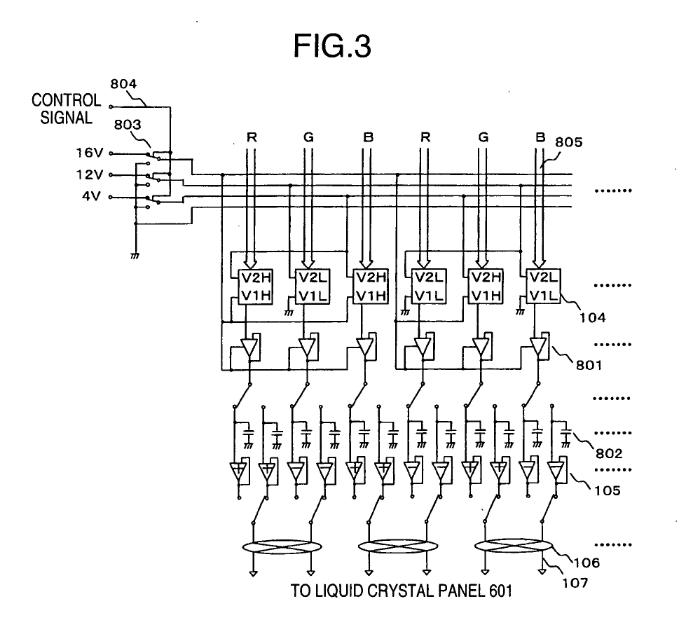

FIG. 3 schematically illustrates a detailed analog circuit part including the R-2R ladder resistor type D/A conversion circuits 104 shown in FIG. 2 and circuits subsequent thereto. The analog circuit part includes the R-2R ladder resistor type D/A conversion circuits 104, buffer means (hereinafter referred to as “S/H charging amplifiers”) 801, capacitance elements (hereinafter referred to as “S/H charging capacitors”) 802, the panel drive amplifiers 105 and the multiplexers 106. Numeral 803 denotes switches, 804 a terminal for control signal, and 805 a bus for transmitting digital display RGB data.

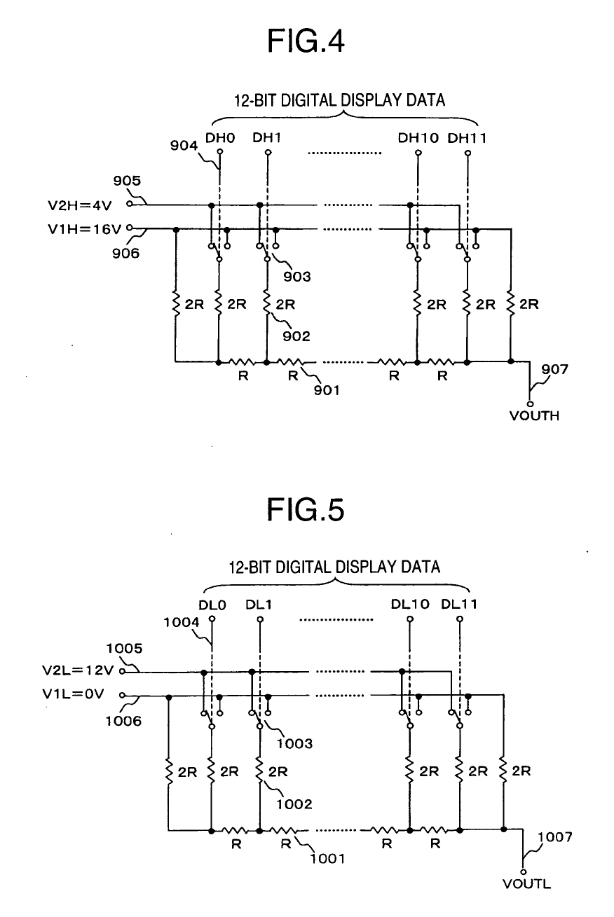

FIG. 4 schematically illustrates the high-potential side D/A conversion circuit of the R-2R ladder resistor type D/A conversion circuits shown in FIG. 3. The high-potential side D/A conversion circuit is of the linear type, which includes two kinds of resistors (resistor R (901) and resistor 2R (902)) and switches 903. Numeral 904 denotes a bus for transmitting 12-bit digital display data, 905 a terminal for a reference voltage V2H, 906 a terminal for a reference voltage V1H, and 907 an output terminal VOUTH.

FIG. 5 schematically illustrates the low-potential side D/A conversion circuit of the R-2R ladder resistor type D/A conversion circuits shown in FIG. 3. The low-potential side D/A conversion circuit is of the linear type, which includes two kinds of resistors (resistor R (1001) and resistor 2R (1002)) and switches 1003. Numeral 1004 denotes a bus for transmitting 12-bit digital display data, 1005 a terminal for a reference voltage V2L, 1006 a terminal for a reference voltage V1L, and 1007 an output terminal VOUTL.

FIGS. 4 and 5 show the case where the digital display data has 12 bits. In the high-potential side R-2R ladder resistor type D/A conversion circuit shown in FIG. 4, the relation of digital input (DH11 to DH0), reference voltages V1H and V2H and analog output VOUTH is expressed by the following equation (1).
VOUTH=V1H+(2/3)×(V2H−V1H)×(DH11/2¹+DH10/2²+DH9/2³+DH8/2⁴+DH7/2⁵+DH6/2⁶+DH5/2⁷+DH4/2⁸+DH3/2⁹+DH2/2¹⁰+DH1/2¹¹+DH0/2¹²) (1)

Accordingly, when the digital input (DH11 to DH0) is varied from (000000000000) to (111111111111), the analog output VOUTH is linearly varied from V1H to V1H+(2/3)×(V2H−V1H)×(4095/4096).

Further, in the low-potential side R-2R ladder resistor type D/A conversion circuit shown in FIG. 5, the relation of digital input (DL11 to DL0), reference voltages V1L and V2L and analog output VOUTL is expressed by the following equation (2).
VOUTL=V1L+(2/3)×(V2L−V1L)×(DL11/2¹+DL10/2²+DL9/2³+DL8/2⁴+DL7/2⁵+DL6/2⁶+DL5/2⁷+DL4/2⁸+DL3/2⁹+DL2/2¹⁰+DL1/2¹¹+DL0/2¹²) (2)

Accordingly, when the digital input (DL11 to DL0) is varied from (000000000000) to (111111111111), the analog output VOUTL is linearly varied from V1L to V1L+(2/3)×(V2L−V1L)×(4095/4096).

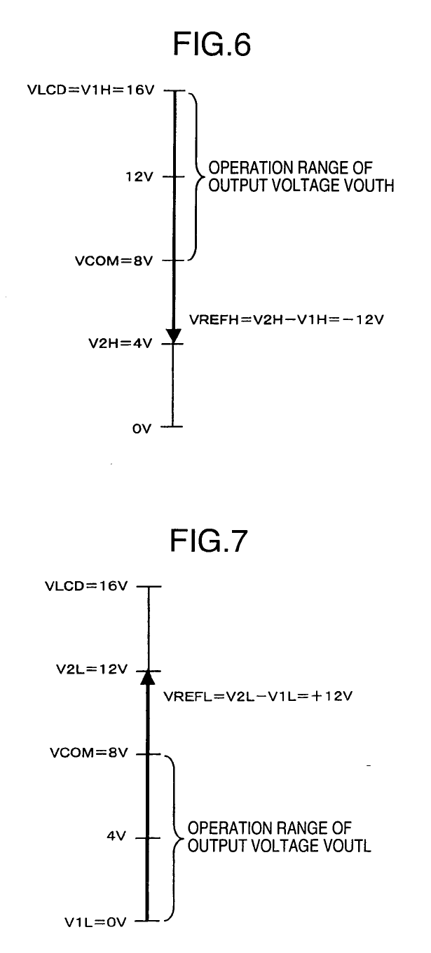

FIG. 6 shows an example of voltages set in the high-potential side D/A conversion circuits. For the clarification of description, the case where the drive voltage range of the liquid crystal panel is set to 16V from 0V to VLCD=V1H=16V and the common potential VCOM of the liquid crystal is set to VLCD/2=8V is described as a definite example.

When the voltages at the terminals of the R-2R ladder resistor circuit shown in FIG. 4 are set to V1H=16V and V2H=4V, the reference voltage VREFH of the ladder resistor circuit is set to V2H−V1H=−12V and the operation range of the output voltage VOUTH of the D/A conversion circuit is set to 8V from VLCD=V1H=16V to VCOM=8V. Accordingly, by setting the terminal voltages as shown in FIG. 6, the R-2R ladder resistor type D/A conversion circuit shown in FIG. 4 can cover all the range of the output voltage higher than VCOM=8V.

FIG. 7 shows an example of voltages set in the low-potential side D/A conversion circuit. When the voltages at the terminals of the R-2R ladder resistor circuit shown in FIG. 5 are set to V1L=0V and V2L=12V, the reference voltage VREFL of the ladder resistor circuit is set to V2L−V1L=+12V and the operation range of the output voltage VOUTL of the D/A conversion circuit is set to 8V from V1L=0V to VCOM=8V. Accordingly, by setting the terminal voltages as shown in FIG. 7, the R-2R ladder resistor type D/A conversion circuit shown in FIG. 5 can cover all the range of the output voltage lower than VCOM=8V.

In the liquid crystal drive circuit of the embodiment, as shown in FIG. 3, the output voltages of the D/A conversion circuits 104 are once stored in the S/H capacitors 802 through the S/H charging amplifiers 801 and then the voltages stored in the S/H capacitors 802 are simultaneously supplied to the liquid crystal panel through the panel drive amplifiers 105 and the multiplexers 106.

Since the capacitance as small as about several picofarads (pF) can be used for the S/H capacitors 802, the analog voltages can be written (sampled) in the S/H capacitors 802 in a very short time as compared with the horizontal scanning time 1 H of the liquid crystal. Accordingly, in the embodiment, the power supplies to the R-2R ladder resistor type D/A conversion circuits 104 are turned on by means of the switches 803 only during the period that the voltages are being written in the S/H capacitors 802 and turned off during other periods except the above-mentioned period, so that the power consumption of the R-2R ladder resistor type D/A conversion circuits 104 is reduced greatly. In addition, the power supply to the S/H charging amplifiers 801 for driving the S/H capacitors 802 can be turned on and off in synchronism with turning on and off of the power supplies to the R-2R ladder resistor type D/A conversion circuits 104, so that the power consumption can be further reduced.

In order to make the operation of charging the analog voltages to the S/H capacitors 802 and the operation of taking out the analog voltages stored in the S/H capacitors 802 to supply the voltages to the liquid crystal panel in parallel, two systems of the S/H capacitors 802 and the panel drive amplifiers 105 are provided.

For example, when the analog voltages are written in the left S/H capacitors 802, the analog voltages stored in the right S/H capacitors 802 are outputted to the liquid crystal panel through the right panel drive amplifiers 105. On the other hand, when the analog voltages are written in the right S/H capacitors 802, the analog voltages stored in the left S/H capacitors 802 are outputted to the liquid crystal panel through the left panel drive amplifiers 105. The two states are switched alternately for each horizontal scanning time to drive the liquid crystal panel.

As shown in FIG. 3, since the two kinds of power supplies (V1H and V2H on the high potential side and V1L and V2L on the low potential side) supplied to the R-2R ladder resistor type D/A conversion circuits 104 and the power supply to the S/H charging amplifiers 801 can be turned on and off in a lump by means of the switches 803 in accordance with the control signal supplied from the timing controller to the control signal terminal 804, the power supplies to the R-2R ladder resistor type D/A conversion circuits 104 and the S/H charging amplifiers 801 can be turned on only during the period that the analog voltages are being written in the S/H capacitors 802 and turned off during other periods except the above-mentioned period to thereby reduce the power consumption of the R-2R ladder resistor type D/A conversion circuits 104 and the S/H charging amplifiers 801 greatly. Further, the power supply to any one of the R-2R ladder resistor type D/A conversion circuits 104 and the S/H charging amplifiers 801 may be turned off to reduce the power consumption.

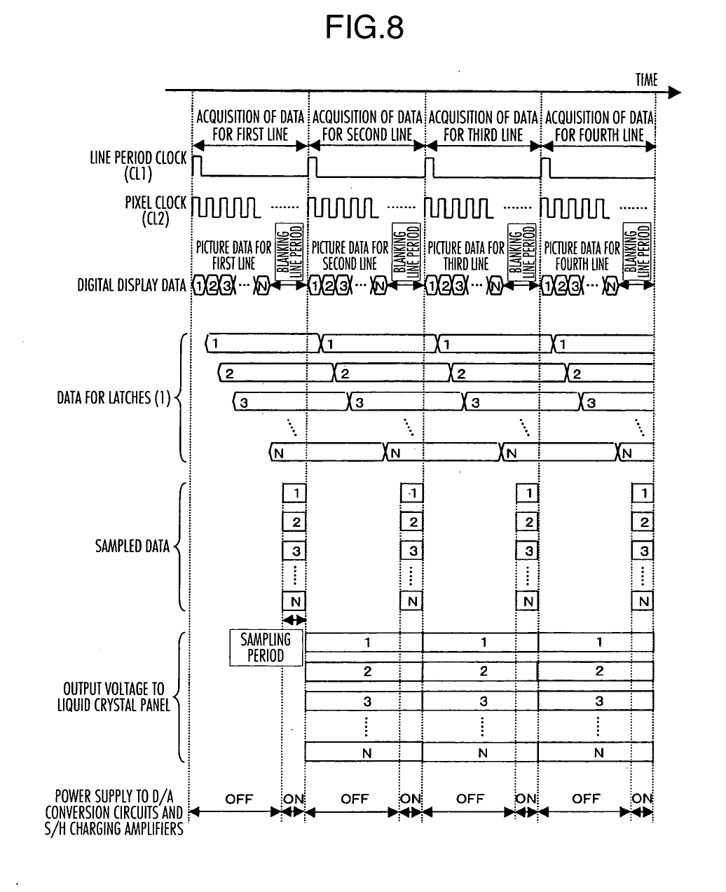

FIG. 8 is a timing chart showing a first example of operation of the liquid crystal drive circuit according to the embodiment. For the clarification of description, the case where the resolution is WXGA (1366 pixels in horizontal direction ×768 pixels in vertical direction) and the frame frequency is 600 Hz is described as a definite example. In this case, the period TCL1 of the line period clock CL1 is 20.96 μseconds and the frequency fCL2 of the pixel clock CL2 is 85.5 MHz. The scanning time 1 H for one line is the same as the period of the line period clock CL1 and is equal to 20.96 μseconds.

As shown in FIGS. 1 and 2, the digital display data supplied from the timing controller 609 are successively taken in the first latch circuits 102 in data for one pixel constituted by 3 data of RGB by action of the shift register 101 operated in synchronism with the pixel clock CL2.

The time required to take in the digital display data for one line is calculated as 1366/85.5 MHz=15.91 μseconds from the frequency fCL2 of the pixel clock CL2 equal to 85.5 MHz. The time obtained by subtracting the time 15.91 μseconds required to take in the digital display data for one line from the horizontal scanning time 1 H=20.96 μseconds is named the flyback time or blanking time Tblank and is calculated as 20.96 μseconds−15.91 μseconds=5.05 μseconds.

As described above, since it is completed in a shorter time than the horizontal scanning time 1H to take in the digital display data for one line, the blanking time Tblank can be assigned to the charging operation (sampling) to the S/H capacitors 802.

In FIG. 8, after it is completed to take in the digital display data for one line, the second latch circuits 103 shown in FIG. 2 simultaneously output the digital display data for one line at the timing earlier than the time that the digital display data for next line is begun to be taken in and the data is converted into analog voltages by the R-2R ladder resistor type D/A conversion circuits 104, so that the analog voltages are begun to be charged in the S/H capacitors 802 by means of the S/H charging amplifiers 801 shown in FIG. 3.

As described above, the analog voltages can be stored in the S/H capacitors 802 in a sufficiently short time as compared with the horizontal scanning time 1 H, so that the sampling to the S/H capacitors 802 can be completed within the blanking period as shown in FIG. 8. After the sampling to the S/H capacitors 802 is completed, the analog voltages stored in the S/H capacitors 802 are taken out at the timing that the data for next line is begun to be taken in to be simultaneously supplied to the liquid crystal panel through the panel drive amplifiers 105 and the multiplexers 106.

As shown in FIG. 8, the power supplies to the R-2R ladder resistor type D/A conversion circuits 104 and the S/H charging amplifiers 801 are turned on only during the period that the sampling is being made to the S/H capacitors 802 and turned off during other periods, so that the power consumption of the liquid crystal drive circuit can be reduced greatly.

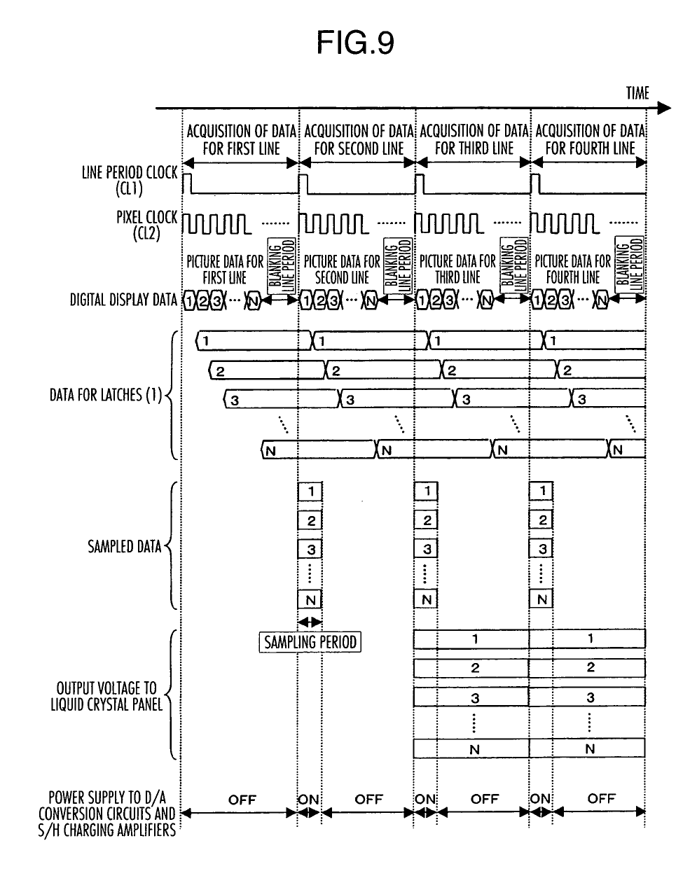

FIG. 9 is a timing chart showing a second example of operation of the liquid crystal drive circuit according to the embodiment. After it is completed to take in the digital display data for one line, the second latch circuits 103 shown in FIG. 2 simultaneously output the digital display data for one line and the sampling to the S/H circuits 111 is begun at the timing that the digital display data for next line is begun to be taken in. In the same manner as FIG. 8, the sampling to the S/H circuits 111 is completed in a very short time as compared with the scanning time 1 H of one line and the analog voltages are held in the S/H circuits 111 until the digital display data for next line is begun to be taken in. Then, the analog voltages are simultaneously supplied to the liquid crystal panel through the panel drive amplifiers 105 and the multiplexers 106.

Even in FIG. 9, the power supplies to the R-2R ladder resistor type D/A conversion circuits 104 and the S/H charging amplifiers 801 are turned on only during the period that the sampling is being made to the S/H circuits 111 and turned off during other periods in the same manner as FIG. 8, so that the power consumption of the liquid crystal drive circuit can be reduced greatly.

Generally, the liquid crystal drive circuit (drain driver LSI) is mounted physically near to the liquid crystal panel 601 as shown in FIG. 1 and accordingly when the power consumption of the liquid crystal drive circuit is increased, the picture quality at part of the liquid crystal panel 601 near to the liquid crystal drive circuit is sometimes deteriorated by generated heat. However, according to the embodiment, since the power consumption of the liquid crystal drive circuit can be reduced greatly, generation of heat in the liquid crystal drive circuit can be suppressed to prevent the deterioration in the picture quality caused by the generated heat.

In the liquid crystal display device according to the embodiment, since the R-2R ladder resistor type D/A conversion circuits of the linear type are applied to the liquid crystal drive circuit, gamma correction means is required separately in order to make gamma correction.

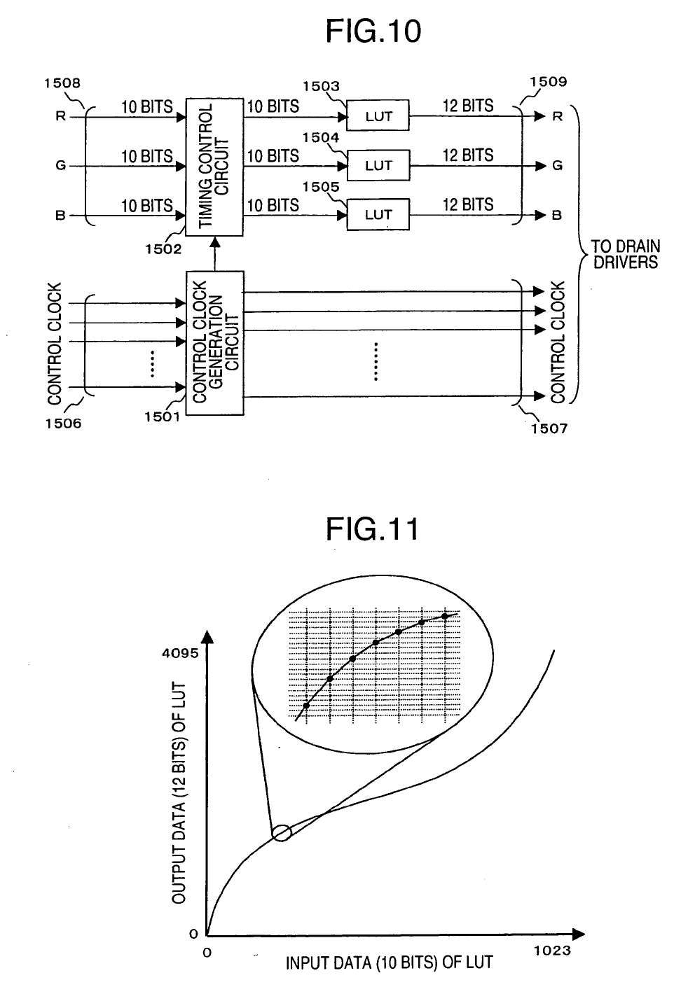

Accordingly, in the embodiment, the timing controller includes data conversion means (hereinafter referred to as “look-up table (LUT)”) provided for each RGB as shown in FIG. 10, so that the digital display data is converted for each RGB. The timing controller shown in FIG. 10 includes a control clock generation circuit 1501, a timing control circuit 1502, a look-up table 1503 for R, a look-up table 1504 for G and a look-up table 1505 for B. Since the conversion relation of the digital display data can be set arbitrarily in the look-up tables (LUT) in advance, the shape of the gamma curve can be set arbitrarily. In FIG. 10, numeral 1506 denotes a bus for input control clock, 1507 a bus for output control clock, 1508 a bus for input digital display data and 1509 a bus for output digital display data.

FIG. 11 is a graph showing conversion of the digital display data by means of the look-up table (hereinafter abbreviated to “LUT”) conceptually. When input data to the LUT is 10 bits, the input data to the LUT can take 1024 values ranging from 0 to 1023. On the other hand, when output data from the LUT is 12 bits, the output data from the LUT can take 4096 values ranging from 0 to 4095. When the conversion relation of the input/output data of the LUT is set to have a nonlinear shape as shown in FIG. 11 by means of the LUT, the nonlinear relation between the display brightness of the liquid crystal display elements and the gradation voltages can be corrected.

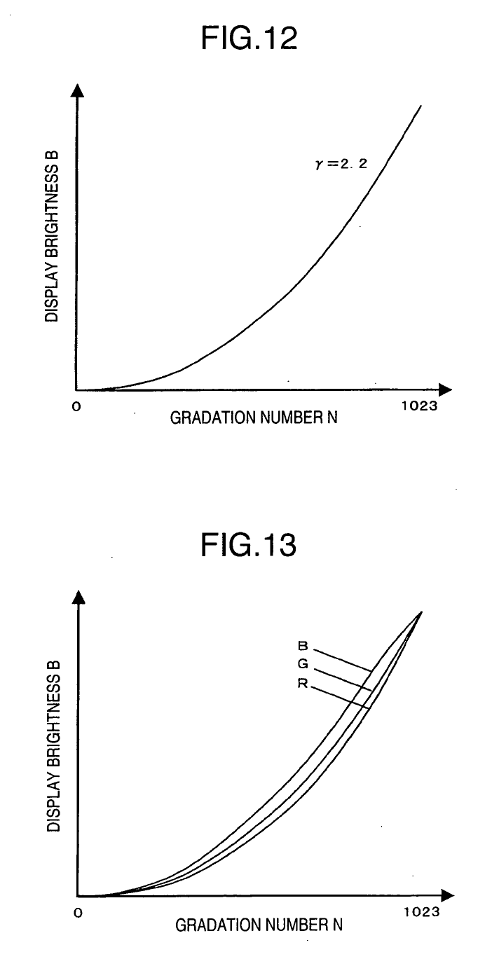

Accordingly, the relation of the gradation number N and the display brightness B in the whole liquid crystal display device can be formed as shown in FIG. 12. FIG. 12 shows the case of γ=2.2. In this case, since the output data of the LUT can be adjusted on a minute scale equal to one fourth of the input data as shown in FIG. 11, the nonlinear and smooth conversion relation can be defined while ensuring the number of output data equal to the number of input data (number of gradations), so that the gamma setting can be made minutely without reducing the number of gradations.

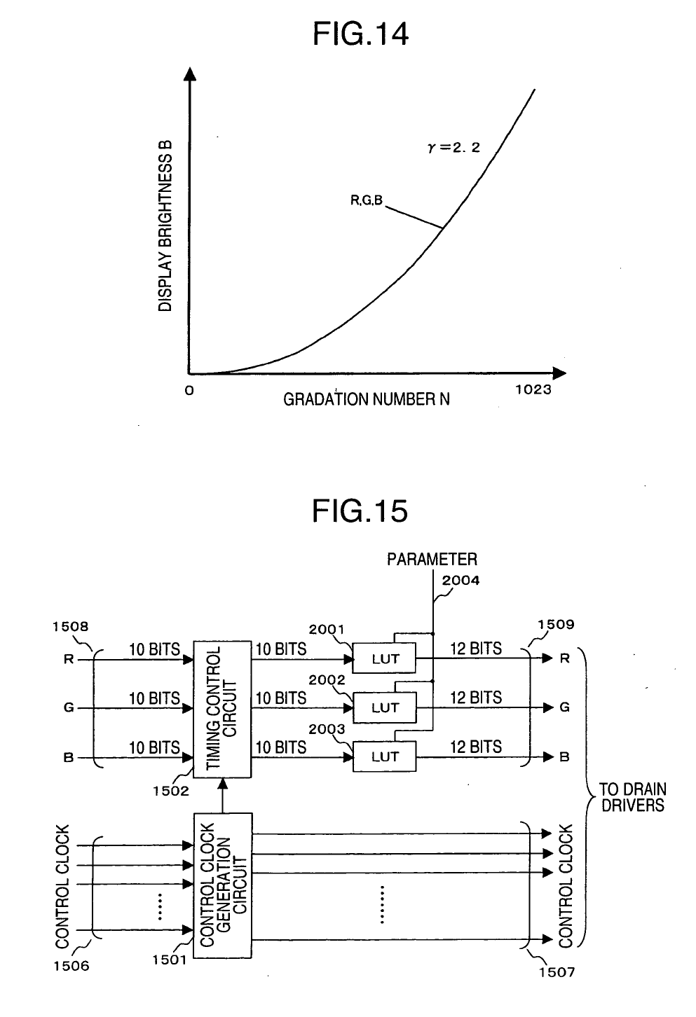

When the gamma setting is made in common to RGB, the relation of the gradation number and the display brightness is slightly shifted or deviated in RGB as shown in FIG. 13 depending on the characteristics of liquid crystal, back light, color filter and the like and color shift occurs depending on the gradation. Accordingly, in the embodiment, the LUTs are provided in the timing controller for each of RGB as shown in FIG. 10, so that the conversion relation of the digital display data is set for each of RGB. In this case, since the gamma setting can be made for each of RGB, the color shift shown in FIG. 13 can be improved as shown in FIG. 14, so that high-quality color reproduction can be attained.

When the R-2R ladder resistor type D/A conversion circuit of the liquid crystal drive circuit is formed with 12 bits as shown in FIGS. 4 and 5, the digital display data of 12 bits outputted by the LUT can be processed by the liquid crystal drive circuit, so that picture having 1024 gradations can be displayed in the whole liquid crystal display device.

Further, as shown in FIG. 15, a plurality of conversion relations of the digital display data may be previously provided in the look-up tables LUT (2001, 2002, 2003) disposed for each RGB in the timing controller and one of the plurality of conversion relations may be selected by a parameter supplied externally. In this case, the parameter supplied externally can be changed to vary the shape of the gamma curve. In FIG. 15, numeral 2004 denotes a terminal for control parameter.

### Embodiment 2

The embodiment 2 of the liquid crystal display device according to the present invention includes the R-2R ladder resistor type D/A conversion circuits and the S/H circuits in the same manner as the embodiment 1 to realize the multi-gradation liquid crystal drive circuit having low cost and low power consumption and is different from the embodiment 1 in that only one system of the liquid crystal drive circuit is provided and the digital display data outputted successively from the latch circuits in synchronism with the pixel clock (CL2) is successively subjected to D/A conversion and sampling.

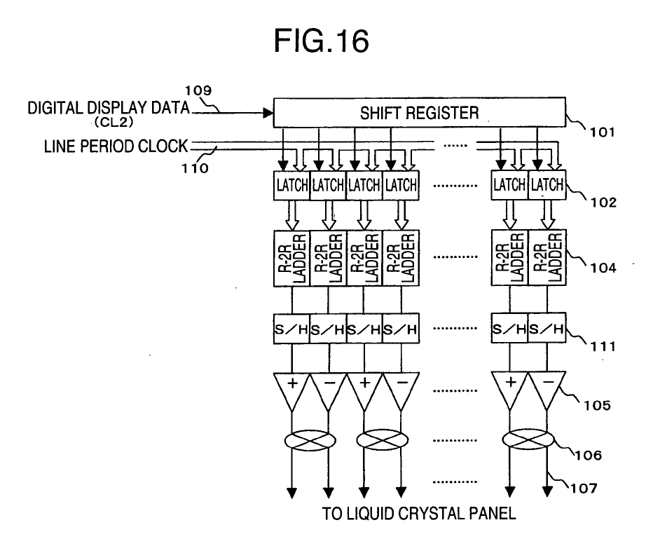

Referring now to FIGS. 16 to 18, the embodiment is described. FIG. 16 schematically illustrates the liquid crystal drive circuit according to the present invention. The liquid crystal drive circuit includes the shift register 101, the latch circuits 102, the R-2R ladder resistor type D/A conversion circuits 104, the sample and hold (S/H) circuits 111, the panel drive amplifiers 105 and the multiplexers 106. Other reference numerals are the same as those of FIG. 2.

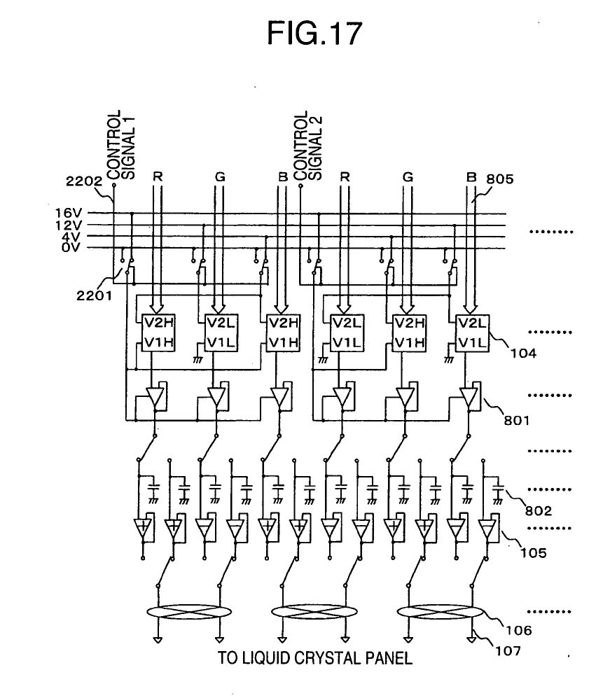

FIG. 17 schematically illustrates an analog circuit part of the liquid crystal drive circuit according to the embodiment. The analog circuit part includes the R-2R ladder resistor type D/A conversion circuits 104, the S/H charging amplifiers 802, the S/H capacitors 802, the panel drive amplifiers 105 and the multiplexers 106.

In FIG. 17, since two kinds of power supplies to the R-2R ladder resistor type D/A conversion circuits 104 and the power supply to the S/H charging amplifiers 801 can be turned on and off for each circuit corresponding to one pixel (circuit corresponding to three drain lines of RGB) independently by means of switches 2201 in accordance with control signals 1, 2, . . . from the timing controller, the power supplies to the R-2R ladder resistor type D/A conversion circuits 104 and the power supply to the S/H charging amplifiers 801 can be turned on only during the period that the analog voltages are being written in the S/H capacitors 802 and turned off during other periods to thereby reduce the power consumption of the R-2R ladder resistor type D/A conversion circuits 104 and the S/H charging amplifiers 801 greatly. In FIG. 17, numeral 2202 denotes a terminal for control signal and other reference numerals are the same as those of FIG. 3.

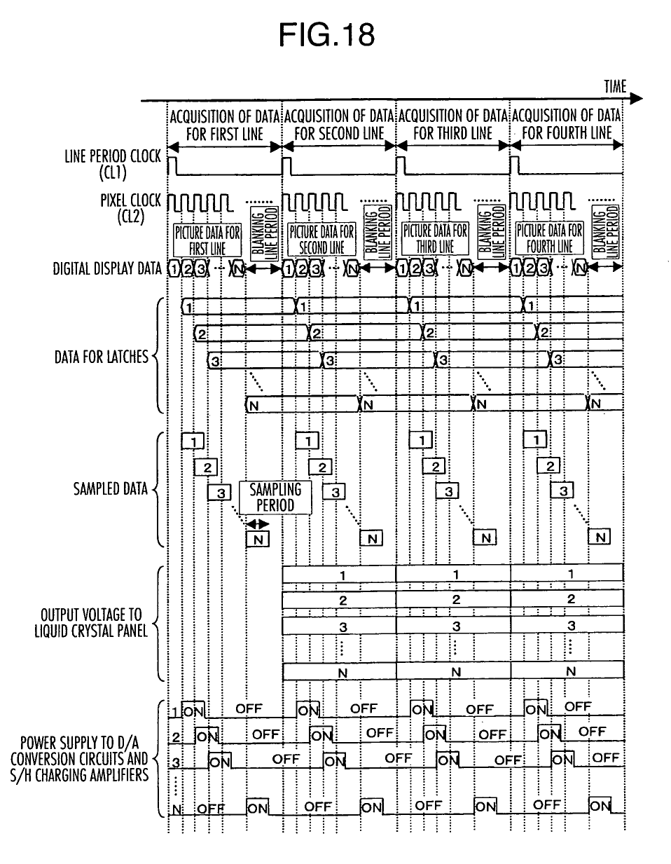

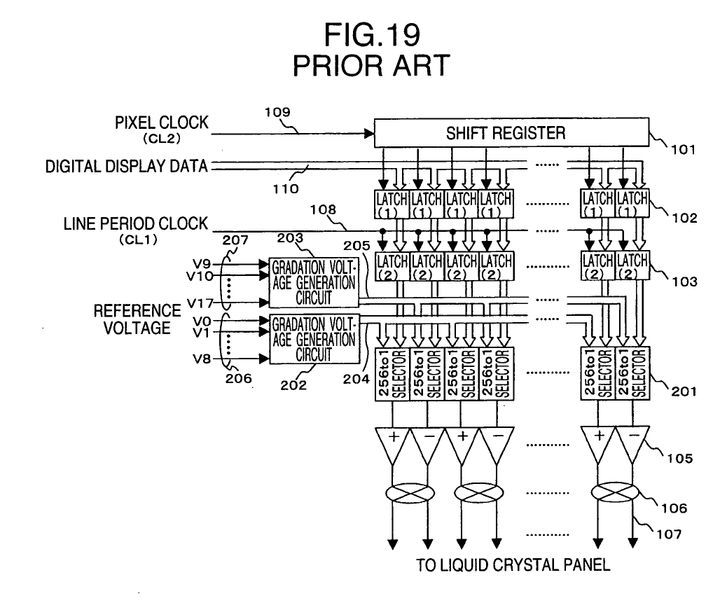

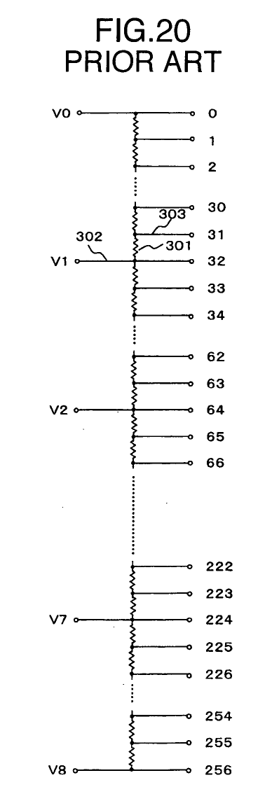

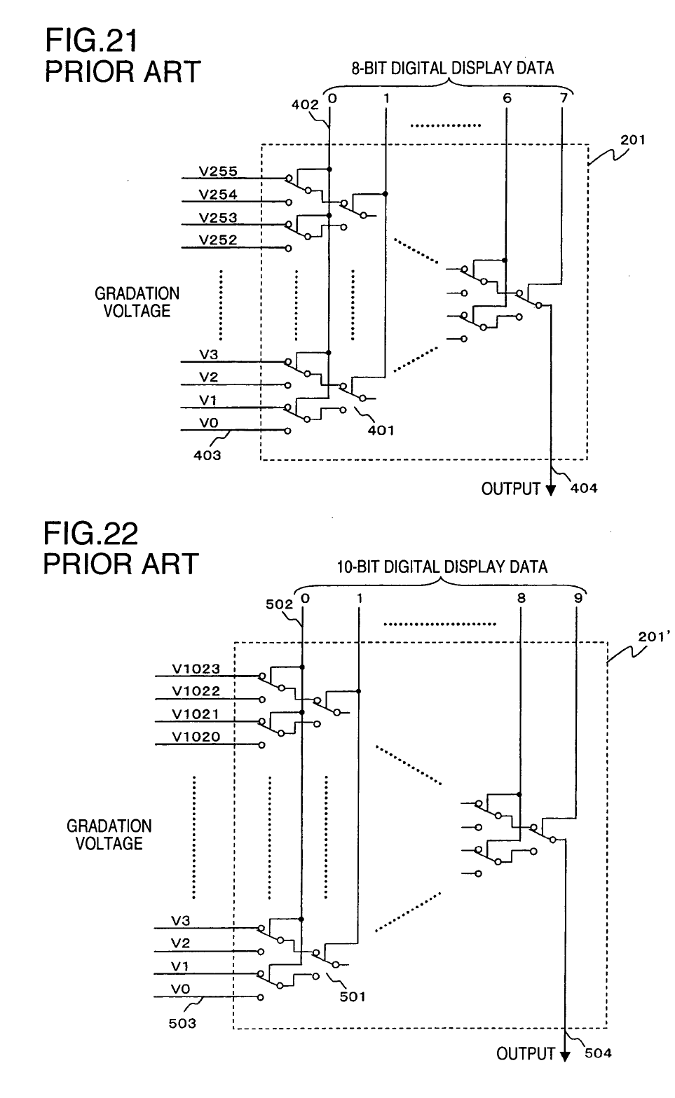

FIG. 18 is a timing chart showing operation of the liquid crystal drive circuit according to the embodiment. The digital display data supplied from the timing controller is successively taken in the latch circuits 102 in data for one pixel constituted by 3 data of RGB by action of the shift register 101 operated in synchronism with the pixel clock CL2. The digital display data taken in the latch circuits 102 is converted into analog voltages immediately by the R-2R ladder resistor type D/A conversion circuits 104 and the charging (sampling) of the analog voltages to the S/H capacitors 802 is started successively.

In the same manner as the embodiment 1, the sampling to the S/H capacitors 802 can be completed in a very short time as compared with the horizontal scanning time 1 H. In the embodiment, since the digital display data supplied from the timing controller is delayed by the time corresponding to one period of the pixel clock CL2 and is taken in the latch circuits 102 pixel by pixel, the start time and the end time of the sampling are delayed for each pixel by one period of the pixel clock CL2.

Even in the embodiment, in the same manner as the embodiment 1, the R-2R ladder resistor type D/A conversion circuits 104 and the S/H charging amplifiers 801 are turned on only during the period that the sampling is being made to the S/H circuits and turned off during other periods, so that the power consumption of the liquid crystal drive circuit can be reduced greatly.

As described above, according to the embodiment, since the power consumption of the liquid crystal drive circuit in the liquid crystal display device can be reduced greatly, generation of heat in the liquid crystal drive circuit can be suppressed to prevent the deterioration in the picture quality caused by heat generated in the liquid crystal drive circuit in the same manner as the embodiment 1.

Further, even in the embodiment, in the same manner as the embodiment 1, the look-up tables for converting the digital display data can be provided in the timing controller independently for each data of RGB as shown in FIG. 10 or 15 to thereby make the gamma setting for each RGB, so that high-quality color reproduction can be attained. In addition, the present invention can be applied to a display device other than the liquid crystal display device, for example, an organic EL display device.

It should be further understood by those skilled in the art that although the foregoing description has been made on embodiments of the invention, the invention is not limited thereto and various changes and modifications may be made without departing from the spirit of the invention and the scope of the appended claims.

1. A display device comprising:
a display panel having a plurality of pixels arranged into a matrix;
a drive circuit for driving the display panel; and
a control circuit for supplying digital display data and control signal to the drive circuit to control the drive circuit;
the drive circuit including a plurality of R-2R ladder resistor type digital-to-analog conversion circuits for converting the digital display data into analog gradation voltages and a plurality of sample and hold circuits in which the converted analog gradation voltages are written alternately by means of two capacitance elements;
the drive circuit taking out the analog gradation voltages stored in the sample and hold circuits alternately to apply the analog gradation voltages to the pixels.

2. A display device according to claim 1, wherein the sample and hold circuits include buffer circuits for driving the capacitance elements.

3. A display device according to claim 1, wherein the control circuit cuts off power supply to the digital-to-analog conversion circuits during other periods except a period that the analog gradation voltages are written in the sample and hold circuits.

4. A display device according to claim 2, wherein the control circuit cuts off power supply to at least one of the digital-to-analog conversion circuits and the buffer circuits during other periods except a period that the analog gradation voltages are written in the sample and hold circuits.

5. A display device according to claim 1, wherein the control circuit includes data conversion circuit for converting the digital display data, and the data conversion circuit controls gradation for displayed picture.

6. A display device according to claim 1, wherein the control circuit includes data conversion circuits for making conversion corresponding to each RGB data of the digital display data independently and controls gradation for each RGB data independently.

7. A display device according to claim 5, wherein the data conversion circuit has a plurality of conversion relations for the digital display data and selects one of the plurality of conversion relations in accordance with parameter supplied from the control circuit.
